(19) United States
(12) Patent Application Publication
(10) Pub. No.: US 2004/0218898 A1
(43) Pub. Date: Nov. 4, 2004

(54) DIGITAL RECORDER

(76) Inventors: Chih-Chuan Cheng, Taipei City (TW); Wen-Sung Tsai, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 10/707,734

(22) Filed: Jan. 8, 2004

(30) Foreign Application Priority Data
May 2, 2003 (TW) 092208062

(51) Int. Cl. H04N 5/76; H04N 5/781

(52) U.S. Cl. 386/46; 386/125

(57) ABSTRACT

A digital recorder capable of outputting a plurality of data formats includes a housing, a multiple format converting module installed in the housing for converting the format of digital audiovisual (AV) signals of the digital recorder, a plurality of connecting ports in different formats installed on the housing and connected to the multiple format converting module, a storage media installed in the housing for storing the digital AV signals of the digital recorder, and a controller electrically connected to the multiple format converting module and the storage media for controlling the operation of the multiple format converting module and the storage media.

### BACKGROUND OF INVENTION

1. Field of the Invention

The present invention relates to a digital recorder, and more specifically, to a digital recorder capable of converting and transmitting the format of digital audiovisual (AV) signals of the digital recorder.

2. Description of the Prior Art

In modern information-oriented society, computers are one of the most important devices processing digital data for the general public. Especially in recent years, as the price of a computer goes down and is very affordable to consumers, computers have become almost necessary both at home and at the office. Additionally, with the improvements in operating speed and the development of multimedia processing, the application of computers is no longer limited to word processing, but has been expanded to include image display and sounds through high operating speed. Because of the expanded development of peripherals, simple operation, and low prices, computers are accelerating the infiltration of digital data into society. Even non-trained people with limited computer experience can easily operate computers to access information. As multimedia-processing technology develops, audiovisual (AV) signal converting devices capable of processing AV signals have become key products in the information technological industry.

Please refer to FIG. 1. FIG. 1 is a block diagram of an AV signal converting device 10 according to the prior art. The AV signal converting device 10 includes an analog-to-digital converter (ADC) 12, a coder/decoder (Codec) 14 and a format converter 16. The ADC 12 is electrically connected to the Codec 14. The ADC 12 receives and converts external analog video signals and accompanying audio signals into corresponding digital video signals and digital audio signals, and then transmits the digital video signals and the digital audio signals to the Codec 14. The Codec 14 is electrically connected to the ADC 12 and the format converter 16. The Codec 14 codes and decodes the received digital video signals and the corresponding digital audio signals from the ADC 12 and generates corresponding AV signals. The Codec 14 then transmits the coded/decoded AV signals to the format converter 16. The format converter 16 is electrically connected to the Codec 14. The format convert 16 converts the formats of the AV signals received from the Codec 14 and then transmits to a format compatible connecting port on a computer. At present, common connecting port formats well known in the industry include PCI, USB1.1, USB2.0, IEEE1349 etc. The AV signal converting device 10 further includes a basic input/output system (BIOS) and an infrared receiving module 19. The BIOS 18 stores programs necessary to the basic operation of the AV signal converting device 10 and provides the stored programs when needed. The infrared receiving module 19 is used for receiving external control signals in infrared format, such as control signals transmitted by an external infrared remote controller, and then for converting the control signals into corresponding control signals to control the operation of the AV signal converting device 10.

The AV signal converting device 10 can convert analog AV signals into corresponding AV signals, and convert the format of the digital AV signals into a data format compatible to a specific connecting port on a computer. The computer or notebook using the AV signal converting device 10 can receive the digital AV signals originally converted from analog signals; and display, store and edit the digital AV signals in the computer system with a connecting port of the same format. However, the format converter 16 of the AV signal converting device 10 corresponds to only one format of the relating connecting port and lacks variations. When using different computers, it is possible that due to the computer not providing a connecting port compatible to the format of the format converter 16, the AV signal converting device 10 cannot operate at all. Moreover, the AV signal converting device 10 can only be used as a data receiving, converting and inputting unit, therefore the AV signal converting device 10 cannot operate independently without connection to a computer or a notebook, so that the range of the application is narrowed. In addition, the AV signal converting device 10 is directly connected to the corresponding connecting port on the computer and lacks of other possible connection methods such as a wireless connection. The arrangement possibilities of the computer with the AV signal converting device 10 are reduced, and this is against the principles of personalization and diversification so strongly emphasized by industrial designers.

### SUMMARY OF INVENTION

It is therefore a primary objective of the present invention to provide a digital recorder to solve the problems of the AV signal converting device according to the prior art mentioned above.

Briefly summarized, a digital recorder according to the present invention is capable of outputting a plurality of data formats, and includes a housing, a multiple format converting module installed in the housing for converting the format of digital AV signals of the digital recorder, a plurality of connecting ports in different formats installed on the housing and connected to the multiple format converting module, a storage media installed in the housing for storing the digital AV signals of the digital recorder, and a controller electrically connected to the multiple format converting module and the storage media for controlling the operation of the multiple format converting module and the storage media, in which one of the plurality of the connecting ports is directly connected to a connecting port on a computer by a cable. The digital recorder further includes an ADC installed in the housing for converting analog AV signals into digital AV signals; a Codec electrically connected to the ADC, the multiple format converting module and the storage media, for receiving, coding and decoding the digital AV signals from the ADC and outputting the digital AV signals to the multiple format converting module and the storage media; an infrared signal receiving module installed on the housing and electrically connected to the controller, for receiving infrared signals to control the operation of the digital recorder; a BIOS for providing programs necessary for basic operations of the digital recorder; and an on-screen display (OSD) controlling unit for displaying operating messages of the digital recorder.

Please note that the storage media can be a hard disk drive, and one of the plurality of connecting ports conforms to one of the standards selected from USB 1.0, USB 2.0, PCI, SCSI or IEEE1394.

Additionally, the digital recorder according to the present invention can include a radio transceiver module connected to the multiple format converting module for transmitting and receiving radio signals, and exchange data with a radio transceiver module on the computer by radio signals.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram of an AV signal converting device according to the prior art.

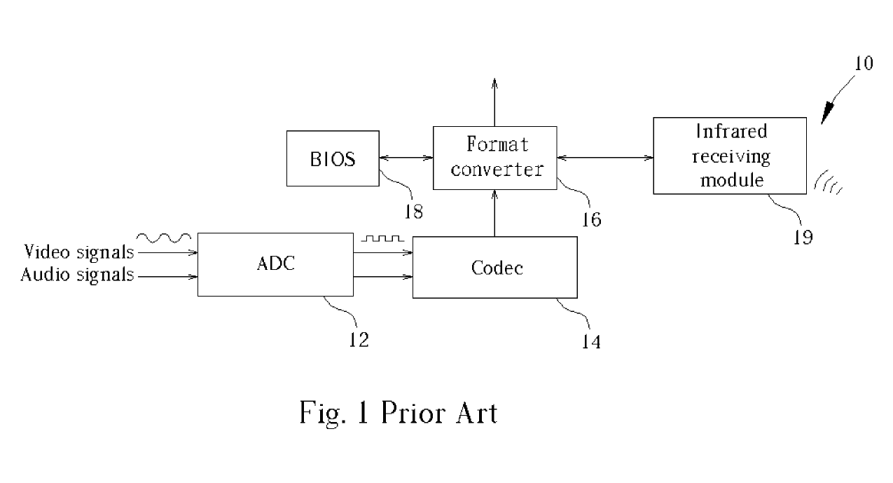

FIG. 2 is a block diagram of a digital recorder according to the first embodiment of the present invention.

FIG. 3 is a block diagram of a digital recorder according to the second embodiment of the present invention.

### DETAILED DESCRIPTION

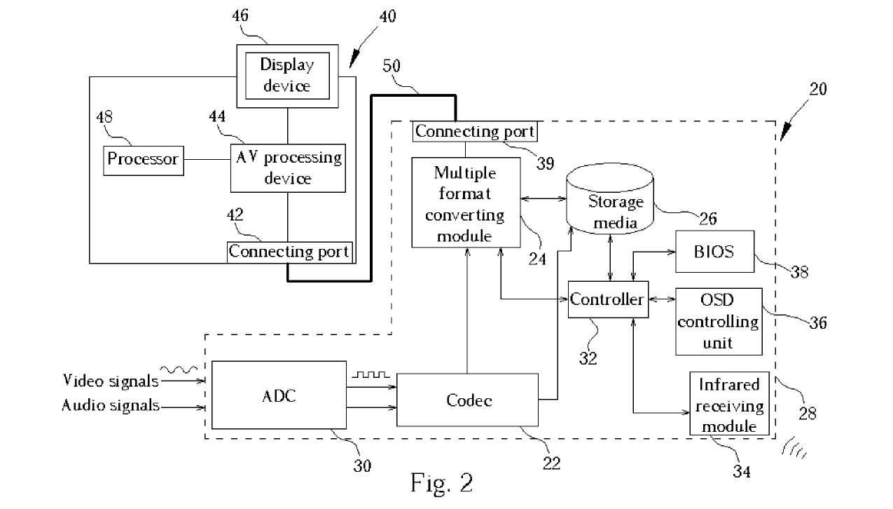

Please refer to FIG. 2. FIG. 2 is a block diagram of a digital recorder 20 according to the first embodiment of the present invention. The digital recorder 20 includes a housing 28, a multiple format converting module 24, a storage media 26, a controller 32 and a plurality of connecting ports 39 in different formats. A computer 40 includes a connecting port 42, a processor 48, an AV processing device 44 and a display device 46. The AV processing device 44 is used to receive and transmit digital AV signals from the connecting port 42 and output the digital AV signals to the display device 46. The display device 46 is used to receive and display the digital AV signals from the AV processing device 44. The structure of the computer 40 is well known in the industry and is not the technology disclosed by the present invention, therefore a further description is hereby omitted. The multiple format converting module 24 is installed in the housing 28. By connecting one of the plurality of connecting ports 39 of different formats to the corresponding connecting port 42 on the computer 40 through a cable 50, the multiple format converting module 24 is connected to the computer 40, for converting digital AV signals data formats of the digital recorder 20 and outputting the format-converted digital AV signals to the connecting port 39. The storage media 26 can be a hard disk drive or other devices having similar functions for storing data and are installed in the housing 28 for storing the digital AV signals of the digital recorder 20. The controller 32 is electrically connected to the multiple format converting module 24 and the storage media 26 and is for controlling the operation of the multiple format converting module 24 and the storage media 26.

The digital recorder 20 further includes an ADC 30, a Codec 22, an infrared signal receiving module 34, a BIOS 38, and an OSD controlling unit 36. The ADC 30 is installed in the housing 28 for converting external analog AV signals into corresponding digital AV signals. The Codec 22 is installed in the housing 28 and electrically connected to the ADC 30, the multiple format converting module 24 and the storage media 26. The Codec 22 is for receiving, coding and decoding the digital AV signals from the ADC 30, and for outputting the digital AV signals to the multiple format converting module 24 and the storage media 26. The infrared signal receiving module 34 is installed on the housing 28 and is electrically connected to the controller 32. It is used for receiving external infrared signals, such as infrared signals from a remote controller, to control the operation of the digital recorder 20. The BIOS 38 is used to provide programs necessary for basic operations of the digital recorder 20. The OSD controlling unit 36 is used to display operating messages of the digital recorder 20 on the display device 46 of the corresponding computer 40.

In the first embodiment of the present invention, the ADC 30 receives and converts external analog video signals and corresponding audio signals into corresponding digital video signals and digital audio signals. It then transmits the digital video signals and the digital audio signals to the Codec 22. The Codec 22 codes and decodes the combined digital AV signals and outputs the coded and decoded digital AV signals to the multiple format converting module 24 and the storage media 26. The coded and decoded digital AV signals output to the storage media 26 are stored in the storage media 26, and the coded and decoded digital AV signals output to the multiple format converting module 24 are converted to different data formats and transmitted to the corresponding computer 40 through the connection by the cable 50 between one of the plurality of the connecting ports 39 in different formats and the connecting port 42 on the computer 40 in the appropriate data format. Through format conversion by the multiple format converting module 24 and connection between one of the plurality of the connecting ports 39 of different formats and the connecting port 42 on the computer 40 in appropriate data format, the digital recorder 20 can exchange data with the corresponding computer 40 using the connecting port 42 in a different data format.

Because the digital recorder 20 includes the storage media 26, even while disconnected from the computer 40, the digital recorder 20 can convert, code and decode analog AV signals into corresponding digital AV signals, and store the digital AV signals in the storage media 26. Therefore, the digital recorder 20 with the storage media 26 can be used separately without connection to the computer 40. The digital recorder 20 can record analog AV signals, and afterwards, output the recorded digital AV signals to the computer 40 when its connecting port 39 is connected by the cable to the connecting port 42 in the same data format on the computer 40, so that users can store and edit the digital AV signals on the computer 40.

In addition, the digital recorder 20 includes the multiple format converting module 24. The multiple format converting module 24 includes a plurality of connecting ports in different data formats conforming to various industrial standards, such as PCI, SCSI, USB1.0, USB2.0, IEEE1394 etc., so that the digital recorder 20 can apply different connecting ports in different data formats for exchanging data with the computer 40, according to user requirements.

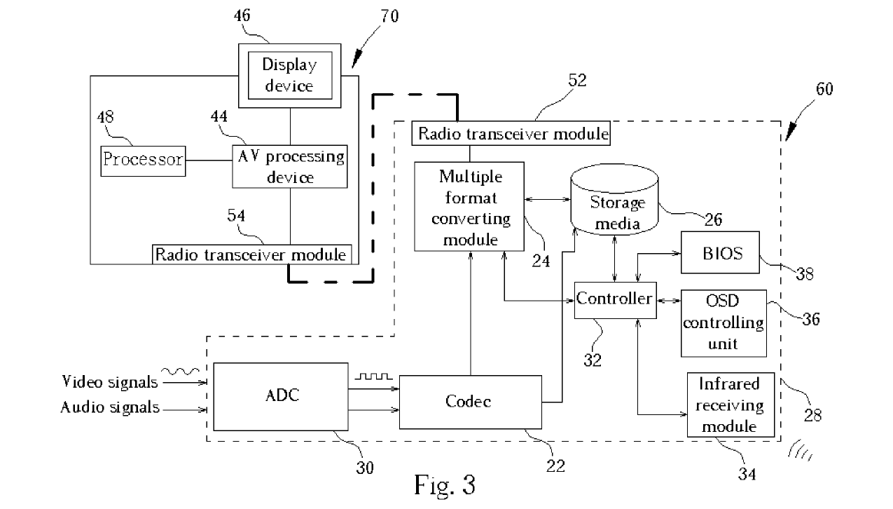

The digital recorder according to the present invention can also be wirelessly connected to the corresponding computer. Please refer to FIG. 3. FIG. 3 is a block diagram of a digital recorder 50 according to the second embodiment of the present invention. Compared with the digital recorder 20 according to the first embodiment, the digital recorder 60 includes a radio transceiver module 52 instead of the connecting ports 39. The radio transceiver module 52 is electrically connected to a multiple format converting module 24, for outputting digital AV signals from the multiple format converting module 24 by radio signals. Meanwhile, a corresponding computer 70 includes a radio transceiver module 54 instead of the connecting port 42. The radio transceiver module 52 is electrically connected to an AV processing device 44, for receiving digital AV signals from the radio transceiver module 52. In the second embodiment, besides the radio transceiver modules 52, 54, the digital recorder 60 and the computer 70 include the same electronic devices connected in the same way and with the same operation as the first embodiment, therefore a further description is hereby omitted. Additionally, please note that the digital recorder 60 is set to be located at the same IP address domain as the computer 70. With well known standards of wireless transmission, such as IEEE 802.11b, and through the radio transceiver modules 52, 54, the digital recorder 60 exchanges data with the computer 70. Because wireless transmission is not the technology disclosed by the present invention, and is well known in the industry, a further description is hereby omitted. Transmission through the cable 50 in the first embodiment and transmission through the radio transceiver modules 52, 54 in the second embodiment are both disclosed in the claims of the present invention.

Please notice that the digital recorder according to the present invention can operate separately from the computer as a set-top box. And also the digital recorder according to the present invention can be a dock for use with a notebook computer.

In contrast to the prior art, the digital recorder according to the present invention utilizes a multiple format converting module and a plurality of connecting ports in different formats, to provide various types of connecting ports to satisfy the requirements of the user. Meanwhile, the digital recorder according to the present invention includes a storage media, so that even when disconnected from a computer, the digital recorder can convert, code and decode analog AV signals into corresponding digital AV signals and store the digital AV signals in the storage media, in order to output the stored digital AV signals after the digital recorder is connected to the computer. Thus the restrictions on AV signal converting devices are reduced so that the digital recorder can operate without being connected to a computer. Moreover, the digital recorder according to the present invention can be connected to a computer using a wired connection with the connecting port, or using a wireless connection using the radio transceiver module. Because a cable is not necessary for the connection, there are many possibilities for arranging the digital recorder and the computer following the trend of personalization and diversification in industrial design.

Those skilled in the art will readily observe that numerous modifications and alterations of the device may be made while retaining the teachings of the invention. Accordingly, the above disclosure should be construed as limited only by the metes and bounds of the appended claims.

1. A digital recorder capable of outputting a plurality of data formats, the digital recorder comprising:
a housing;
a multiple format converting module installed in the housing for converting the format of digital audiovisual (AV) signals of the digital recorder;
a plurality of connecting ports in different formats installed on the housing and connected to the multiple format converting module;
a storage media installed in the housing for storing the digital AV signals of the digital recorder; and
a controller electrically connected to the multiple format converting module and the storage media, for controlling the operation of the multiple format converting module and the storage media.

2. The digital recorder of claim 1 wherein one of the plurality of the connecting ports is directly connected to a connecting port on a computer by a cable.

3. The digital recorder of claim 1 further comprising:
an analog-to-digital converter (ADC) installed in the housing for converting analog AV signals into digital AV signals; and
a coder/decoder (CODEC) electrically connected to the ADC, the multiple format converting module, and the storage media; for receiving, coding and decoding the digital AV signals from the ADC, and outputting the digital AV signals to the multiple format converting module and the storage media.

4. The digital recorder of claim 1 further comprising an infrared signal receiving module installed on the housing and electrically connected to the controller, for receiving infrared signals to control the operation of the digital recorder.

5. The digital recorder of claim 1 further comprising a basic input/output system (BIOS) for providing programs necessary for basic operations of the digital recorder.

6. The digital recorder of claim 1 further comprising an on-screen display (OSD) controlling unit for displaying operating messages of the digital recorder.

7. The digital recorder of claim 1 wherein the storage media is a hard disk drive.

8. The digital recorder of claim 1 wherein one of the plurality of connecting ports conforms to one of the standards selected from USB 1.0, USB 2.0, PCI, SCSI or IEEE1394.

9. The digital recorder of claim 1 being a dock for a notebook.

10. The digital recorder of claim 1 further comprising a radio transceiver module connected to the multiple format converting module for transmitting and receiving radio signals.

11. The digital recorder of claim 10 wherein the radio transceiver module exchanges data with a radio transceiver module on the computer by radio signals.

12. The digital recorder of claim 11 wherein the computer comprises a processor, an AV processing device connecting to the radio transceiver module on the computer for receiving and converting the digital AV signals from the digital recorder, and a display device for displaying the digital AV signals from the AV processing device.

13. The digital recorder of claim 2 wherein the computer further comprises a processor, an AV processing device connecting to the connecting port on the computer for receiving and converting the digital AV signals from the digital recorder, and a display device for displaying the digital AV signals from the AV processing device.
